(19) United States
(12) Patent Application Publication
(10) Pub. No.: US 2024/0344215 A1
(43) Pub. Date: Oct. 17, 2024

(54) POROUS BASE LAYER AND METHOD AND APPARATUS FOR MANUFACTURING THE SAME

(71) Applicants: HYUNDAI MOTOR COMPANY, Seoul (KR); Kia Corporation, Seoul (KR); LT Metal Co., Ltd., Incheon (KR)

(72) Inventors: Young June PARK, Yangpyeong-gun (KR); Pil Young LEE, Yongin-si (KR); Seung Ho YANG, Incheon (KR); Jae Gwan SHIN, Asan-si (KR); Sun Ki HONG, Anyang-si (KR); Hyeon Jeong JO, Seoul (KR); Hyo Yoon PARK, Seoul (KR); Sung Won LEE, Seoul (KR)

(73) Assignees: HYUNDAI MOTOR COMPANY, Seoul (KR); Kia Corporation, Seoul (KR); LT Metal Co., Ltd., Incheon (KR)

(21) Appl. No.: 18/233,543

(22) Filed: Aug. 14, 2023

(30) Foreign Application Priority Data
Apr. 11, 2023 (KR) 10-2023-0047635

(51) Int. Cl. C25B 11/031; B22F 3/22; C25B 9/23

(52) U.S. Cl. CPC C25B 11/031; B22F 3/22; C25B 9/23; B22F 2301/205; B22F 2304/10; B22F 2998/10; H01M 8/0232; H01M 8/1004

(57) ABSTRACT

A porous base layer includes a base layer body stacked on a membrane electrode assembly (MEA), and a protrusion pattern provided on one surface of the base layer body that faces the membrane electrode assembly, the protrusion pattern being configured to define a guide flow path for guiding a movement of a target fluid between the membrane electrode assembly and the base layer body, obtaining advantageous effect of improving performance and operational efficiency.

### CROSS-REFERENCE TO RELATED APPLICATION

The present application claims priority to Korean Patent Application No. 10-2023-0047635 on Apr. 11, 2023, the entire contents of which is incorporated herein for all purposes by this reference.

### BACKGROUND OF THE PRESENT DISCLOSURE

### Field of the Present Disclosure

The present disclosure relates to a porous base layer and a method and apparatus for manufacturing the same, and more particularly, to a porous base layer and a method and apparatus for manufacturing the same, which are capable of improving performance and operational efficiency.

### Description of Related Art

There is a consistently increasing demand for research and development on alternative energy to cope with global warming and depletion of fossil fuel. Hydrogen energy is attracting attention as a practical solution for solving environment and energy issues.

In particular, because hydrogen has high energy density and properties suitable for application in a grid-scale, hydrogen is in the limelight as a future energy carrier.

A water electrolysis stack, which is one of electrochemical devices, refers to a device that produces hydrogen and oxygen by electrochemically decomposing water. The water electrolysis stack may be configured by stacking several tens or several hundreds of water electrolysis cells (unit cells) in series.

A membrane-electrode assembly (MEA) is positioned at an innermost side of the unit cell of the water electrolysis stack. The membrane-electrode assembly includes a perfluorinated sulfonic acid ionomer-based electrolyte membrane capable of moving hydrogen ions (protons), and an anode electrode and a cathode electrode respectively disposed on two opposite surfaces of the electrolyte membrane.

Furthermore, a porous transport layer (PTL), a gas diffusion layer (GDL), and a gasket may be stacked on each of the outer portions (outer surfaces) of the membrane-electrode assembly (MEA) on which the anode and the cathode are positioned. A separator (or bipolar plate) may be disposed on an outer side (outer surface) of the porous transport layer (PTL) and the gas diffusion layer (GDL). The separator includes flow paths (flow fields) through which a reactant, a coolant, and a product produced by a reaction flow, or the separator may include a structure which may be substituted for the flow paths.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a porous base layer and a method and apparatus for manufacturing the same, which are configured for improving performance and operational efficiency.

The present disclosure has been made in an effort to effectively diffuse a target fluid and minimize a site of a membrane electrode assembly to which the target fluid is not supplied.

Among other things, the present disclosure has been made in an effort to effectively diffuse the target fluid in an in-plane direction of the membrane electrode assembly.

The present disclosure has also been made in an effort to improve transmittance of the porous base layer and improve efficiency in moving the target fluid (performance in transmitting the target fluid).

The present disclosure has also been made in an effort to improve stability, reliability, and durability.

The objects to be achieved by the exemplary embodiments are not limited to the above-mentioned objects, but also include objects or effects which may be understood from the solutions or embodiments described below.

An exemplary embodiment of the present disclosure provides a porous base layer including: a base layer body stacked on a membrane electrode assembly (MEA); and a protrusion pattern provided on one surface of the base layer body that faces the membrane electrode assembly, the protrusion pattern being configured to define a guide flow path for guiding a movement of a target fluid between the membrane electrode assembly and the base layer body.

According to the exemplary embodiment of the present disclosure, the protrusion pattern may include a plurality of protrusions protruding from the one surface of the base layer body and spaced from one another, and the guide flow path may be defined as a space between the plurality of protrusions.

According to the exemplary embodiment of the present disclosure, the guide flow path may be defined in an in-plane direction of the base layer body.

According to the exemplary embodiment of the present disclosure, the guide flow path may include: a first flow path defined in a first direction thereof; and a second flow path defined in a second direction intersecting the first direction and configured to fluidically-communicate with the first flow path.

According to the exemplary embodiment of the present disclosure, the first flow path may be provided as a plurality of first flow paths spaced from one another in the second direction, and the second flow path may be provided as a plurality of second flow paths spaced from one another in the first direction thereof.

According to the exemplary embodiment of the present disclosure, the second flow path may be provided to be perpendicular to the first flow path.

According to the exemplary embodiment of the present disclosure, at least one of the first and second flow paths may be defined in a straight shape.

According to the exemplary embodiment of the present disclosure, at least one of the first and second flow paths may be defined in a curved shape.

According to the exemplary embodiment of the present disclosure, a height of the protrusion may be defined to be 1 to 20 μm.

Another exemplary embodiment of the present disclosure provides an apparatus for manufacturing a porous base layer, the apparatus including: a release sheet configured to define a coating surface coated with a base layer slurry for forming a porous base layer; and a concave-convex pattern provided on the coating surface of the release sheet, in which the concave-convex pattern is configured to form a protrusion pattern that defines a guide flow path, which guides a movement of a target fluid, on one surface of the porous base layer.

According to the exemplary embodiment of the present disclosure, the concave-convex pattern and the release sheet may be provided as a unitary one-piece structure.

According to the exemplary embodiment of the present disclosure, the concave-convex pattern may include: a crest portion protruding from one surface of the release sheet; and a trough portion connected to an end portion of the crest portion to define a continuous waveform together with the crest portion in an in-plane direction of the release sheet, and the guide flow path may be formed to correspond to the trough portion.

According to the exemplary embodiment of the present disclosure, the crest portion and the trough portion may be respectively provided as a plurality of crest portions and a plurality of trough portions to define a lattice shape.

According to the exemplary embodiment of the present disclosure, the crest portions and the trough portions may be alternately disposed in a first direction and a second direction intersecting the first direction.

According to the exemplary embodiment of the present disclosure, the first direction may be defined to be perpendicular to the second direction thereof.

Various exemplary embodiments of the present disclosure provides a method of manufacturing a porous base layer, the method including: providing a release sheet including a concave-convex pattern on one surface; forming a porous base layer by applying base layer slurry on one surface of the release sheet to cover the concave-convex pattern; and removing the release sheet from the porous base layer, in which when the release sheet is removed from the porous base layer, a protrusion pattern, which defines a guide flow path corresponding to the concave-convex pattern, is formed on one surface of the porous base layer.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view for explaining a porous base layer according to an exemplary embodiment of the present disclosure.

FIG. 2 is a view for explaining a protrusion pattern of the porous base layer according to the exemplary embodiment of the present disclosure.

FIG. 3 is a block diagram for explaining a method of manufacturing the porous base layer according to the exemplary embodiment of the present disclosure.

FIG. 4 is a view for explaining an apparatus for manufacturing the porous base layer according to the exemplary embodiment of the present disclosure.

FIG. 5, FIG. 6, FIG. 7 and FIG. 8 are views for explaining a concave-convex pattern of the apparatus for manufacturing the porous base layer according to the exemplary embodiment of the present disclosure.

FIG. 9 and FIG. 10 are views for explaining a process of manufacturing the concave-convex pattern of the apparatus for manufacturing the porous base layer according to the embodiment.

FIG. 11 is a view for explaining a process of applying base layer slurry in the method of manufacturing the porous base layer according to the exemplary embodiment of the present disclosure.

FIG. 12 is a view for explaining a process of removing a release sheet in the method of manufacturing the porous base layer according to the exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings.

However, the technical spirit of the present disclosure is not limited to various exemplary embodiments described herein but may be implemented in various different forms. One or more of the constituent elements in the exemplary embodiments may be selectively combined and substituted for use within the scope of the technical spirit of the present disclosure.

Furthermore, unless otherwise specifically and explicitly defined and stated, the terms (including technical and scientific terms) used in the exemplary embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

Furthermore, the terms used in the exemplary embodiments of the present disclosure are for explaining the embodiments, not for limiting the present disclosure.

In the present specification, unless stated otherwise, a singular form may also include a plural form. The expression “at least one (or one or more) of A, B, and C” may include one or more of all combinations that may be made by combining A, B, and C.

In addition, the terms such as first, second, A, B, (a), and (b) may be used to describe constituent elements of the exemplary embodiments of the present disclosure.

These terms are used only for discriminating one constituent element from another constituent element, and the nature, the sequences, or the orders of the constituent elements are not limited by the terms.

Furthermore, when one constituent element is referred to as being ‘connected’, ‘coupled’, or ‘attached’ to another constituent element, one constituent element may be connected, coupled, or attached directly to another constituent element or connected, coupled, or attached to another constituent element through yet another constituent element interposed therebetween.

Furthermore, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

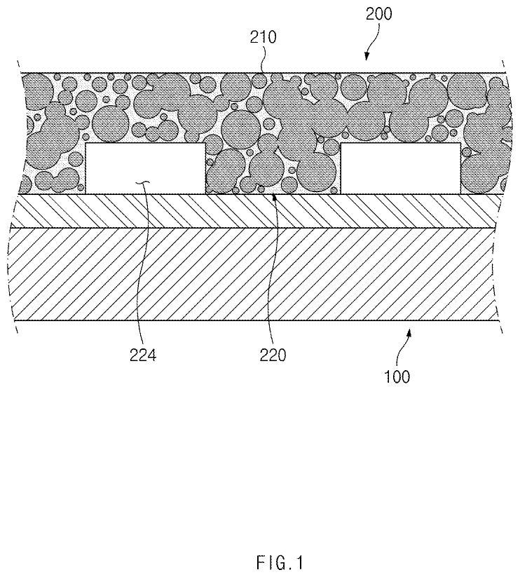

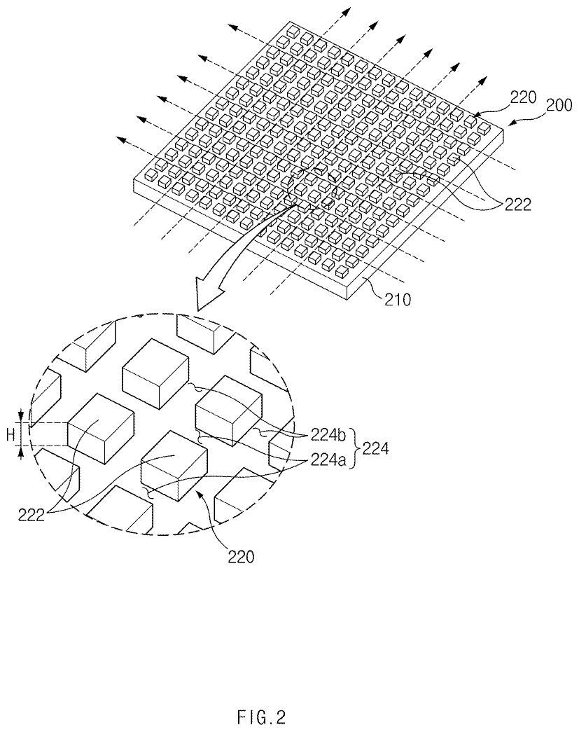

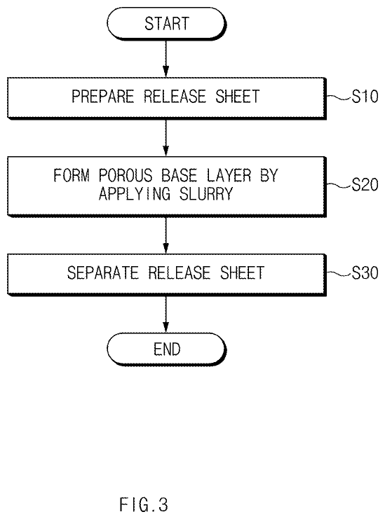

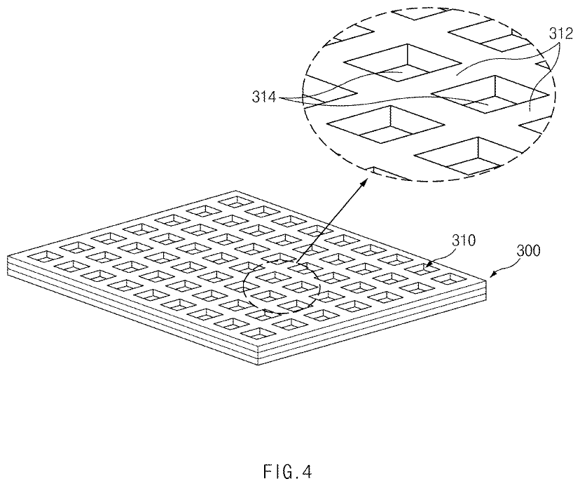

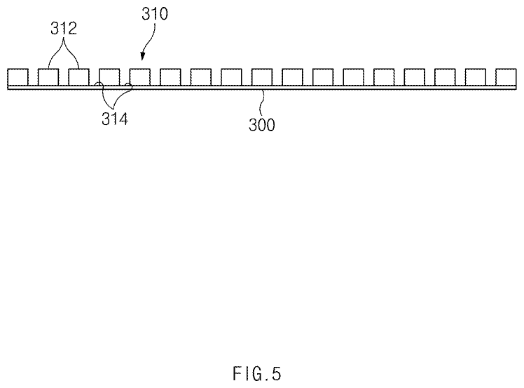

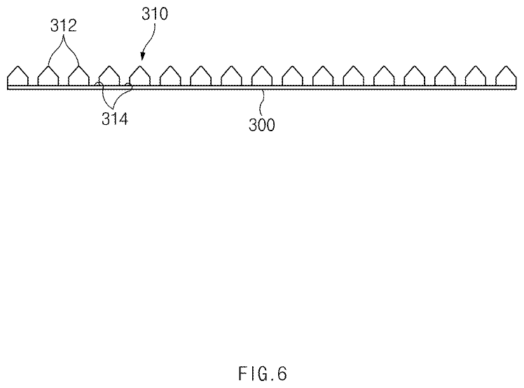

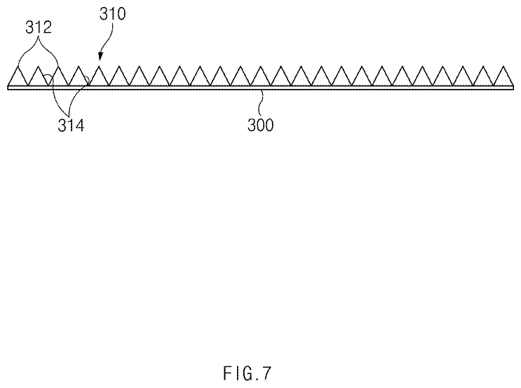

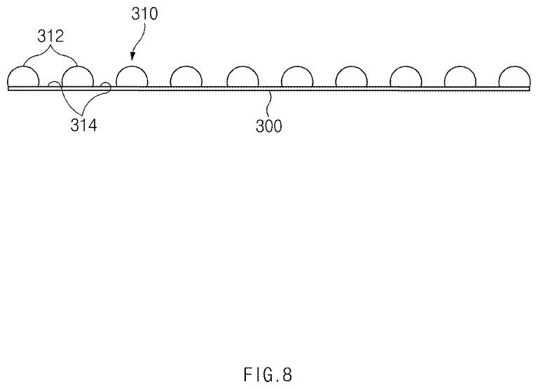

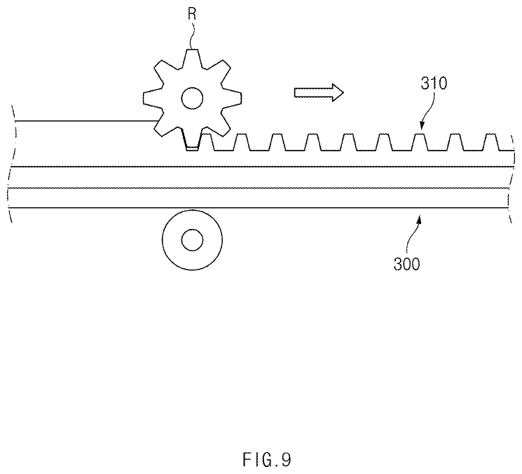

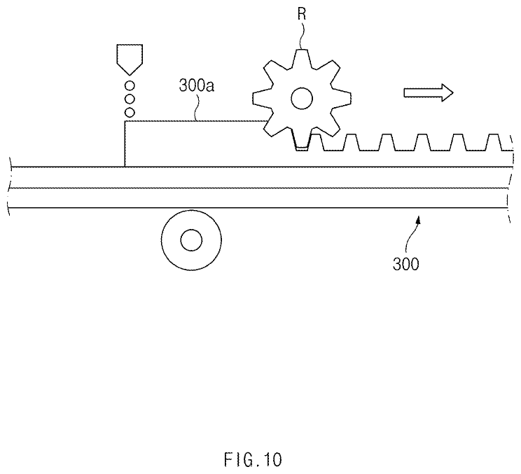

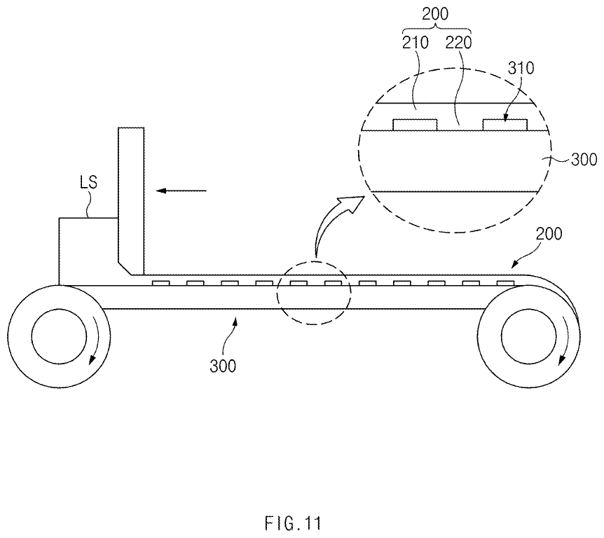

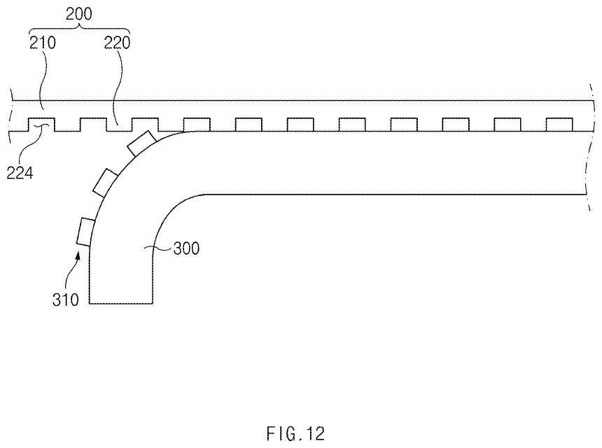

With reference to FIG. 1, FIG. 2, FIG. 3, FIG. 4, FIG. 5, FIG. 6, FIG. 7, FIG. 8, FIG. 9, FIG. 10, FIG. 11 and FIG. 12, a porous base layer 200 according to the exemplary embodiment of the present disclosure includes a base layer body 210 stacked on a membrane electrode assembly (MEA) 100, and a protrusion pattern 220 provided on one surface of the base layer body 210 that faces the membrane electrode assembly 100, the protrusion pattern 220 being configured to define guide flow paths 224 to guide a movement of a target fluid between the membrane electrode assembly 100 and the base layer body 210.

For reference, the porous base layer 200 according to the exemplary embodiment of the present disclosure, together with the membrane electrode assembly (MEA) 100, may form an electrochemical device.

In the instant case, the electrochemical device is defined as including both a water electrolysis stack configured to produce hydrogen and oxygen by electrochemically decomposing water and a fuel cell stack configured to generate electrical energy through a chemical reaction of fuel (e.g., hydrogen).

Hereinafter, an example will be described in which the electrochemical device according to the exemplary embodiment of the present disclosure is used as the water electrolysis stack that produces hydrogen and oxygen by decomposing water through an electrochemical reaction.

This is to ensure performance and operational efficiency of the electrochemical device and improve durability and reliability of the electrochemical device.

That is, the performance and output of the electrochemical device is determined depending on a transfer flow rate of the target fluid (e.g., water) to be transferred to the membrane electrode assembly 100. Therefore, it is necessary to ensure a sufficient transfer flow rate of the target fluid to be transferred to the membrane electrode assembly 100 to improve the performance and output of the electrochemical device. Furthermore, it is necessary to uniformly disperse (diffuse) the target fluid over the entire section of the membrane electrode assembly 100.

However, generally, in case that there is a closed pore section (closed pore area) in which closed pores are formed in one surface of the porous base layer being in contact with the membrane electrode assembly 100, the target fluid hardly passes through the closed pore section, which causes a problem in that it is difficult to form a smooth flow of the target fluid in a direction from the separator toward the membrane electrode assembly. For the present reason, there is a problem in that it is difficult to ensure a sufficient transfer flow rate of the target fluid to be transferred to the membrane electrode assembly (it is difficult to ensure a reaction area of the target fluid to be supplied to the membrane electrode assembly and ensure efficiency in transferring the target fluid), which makes it difficult to improve the performance and output of the electrochemical device.

Moreover, generally, there is a problem in that a dead zone, in which the target fluid cannot be supplied to a particular site of the membrane electrode assembly, is formed by the closed pore section. For the present reason, there is a problem in that the durability of the membrane electrode assembly and the porous base layer deteriorate.

However, in the exemplary embodiment of the present disclosure, the protrusion pattern 220, which defines the guide flow paths 224 for guiding the target fluid, is provided on one surface of the base layer body 210 that faces the membrane electrode assembly 100. Therefore, it is possible to obtain an advantageous effect of uniformly dispersing (diffusing) the target fluid over the entire section of the membrane electrode assembly 100 while ensuring a sufficient transfer flow rate of the target fluid to be transferred to the membrane electrode assembly 100.

Among other things, in the exemplary embodiment of the present disclosure, the protrusion pattern 220, which defines the guide flow paths 224, is provided on a contact surface of the porous base layer 200 which is in contact with the membrane electrode assembly 100 (one surface of the base layer body that faces the membrane electrode assembly) so that the target fluid may be dispersed (diffused) along the guide flow paths 224 even though the closed pore section (closed pore area) is present on the contact surface of the porous base layer 200. Therefore, it is possible to obtain an advantageous effect of ensuring the reaction area of the target fluid to be supplied to the membrane electrode assembly 100 and ensure efficiency in transferring the target fluid.

Moreover, according to the exemplary embodiment of the present disclosure, the target fluid having passed through the porous base layer 200 may be uniformly dispersed (diffused) over the entire section of the membrane electrode assembly 100 along the guide flow paths 224. Therefore, it is possible to obtain an advantageous effect of minimizing the occurrence of the dead zone and improving the durability of the membrane electrode assembly 100 and the porous base layer 200.

Furthermore, in the exemplary embodiment of the present disclosure, the guide flow path 224 (an empty space larger in size of the pore of the porous base layer) is provided on the contact surface of the porous base layer 200 which is in contact with the membrane electrode assembly 100 (one surface of the base layer body that faces the membrane electrode assembly) so that the porosity of the porous base layer 200 may be improved. Therefore, it is possible to improve the transmittance of the target fluid with respect to the porous base layer 200. Furthermore, it is possible to shorten a movement route for the target fluid passing through the porous base layer 200 by reducing the tortuosity in a thickness direction of the porous base layer 200 (an actual movement route compared to a shortest straight route in which the target fluid passes).

The water electrolysis stack (electrochemical device) may be provided by stacking a plurality of unit cells in a reference stacking direction thereof.

The unit cell may include a reaction layer and the separators stacked on one surface and the other surface of the reaction layer. The water electrolysis stack may be configured by stacking the plurality of unit cells in the reference stacking direction and assembling endplates to the two opposite end portions of the plurality of unit cells.

The reaction layer may have various structures configured for generating the electrochemical reaction of a target fluid (e.g., water). The present disclosure is not restricted or limited by the type and structure of the reaction layer.

For example, the reaction layer may include the membrane electrode assembly (MEA) 100, and the porous base layers 200 provided to be in close contact with two opposite surfaces of the membrane electrode assembly 100.

The membrane electrode assembly 100 may be variously changed in structure and material in accordance with required conditions and design specifications, and the present disclosure is not limited or restricted by the structure and material of the membrane electrode assembly 100.

For example, the membrane electrode assembly 100 may be configured by attaching catalyst electrode layers (e.g., an anode layer and a cathode layer), in which electrochemical reactions are generated, to two opposite surfaces of an electrolyte membrane (e.g., a perfluorinated sulfonic acid ionomer-based electrolyte membrane).

For reference, water supplied to the anode layer, which is an oxidation electrode for the water electrolysis, is separated into hydrogen ions (protons), electrons, and oxygen. The hydrogen ions move to the cathode layer, which is a reduction electrode, through the electrolyte membrane, and the electrons move to a cathode through an external circuit. Furthermore, oxygen gas may be discharged to an anode outlet, and hydrogen ions and electrons may be converted into hydrogen gas at a cathode and then discharged to a cathode outlet.

The separators, together with the reaction layer (membrane electrode assembly), may form a single unit cell (water electrolysis cell). The separators is configured to separate and block water (or water and oxygen) at the anode side and hydrogen produced at the cathode side by the reaction layer. The separators may also be configured to ensure a flow path (flow field) of the fluid.

Furthermore, the separators may also be configured to distribute heat, which is generated from the unit cell, to the entire unit cell, and the excessively generated heat may be discharged to the outside by water flowing along the separators.

For reference, in the exemplary embodiment of the present disclosure, the separators are defined as including both an anode separator and a cathode separator that independently define the flow paths (channels) for water (or water and oxygen) and the flow paths (channels) for hydrogen in the water electrolysis stack.

For example, the separator (anode separator), which faces one surface of the membrane electrode assembly 100, may define a flow path (channel) for water (or water and oxygen). The separator (cathode separator), which faces the other surface of the membrane electrode assembly 100, may define a flow path (channel) for hydrogen.

The separator may be stacked on the membrane electrode assembly 100. Channels, through which the target fluid (hydrogen or water) flows, may be formed in one surface of the separator that faces the membrane electrode assembly 100. Lands, which are in contact with the porous base layer 200, may be formed on one surface of the separator that faces the membrane electrode assembly 100. Cooling channels, through which a coolant flows, may be formed in the other surface of the separator.

The separator may have various structures and be made of various materials in accordance with required conditions and design specifications. The present disclosure is not restricted or limited by the structure and material of the separator.

For example, the separator may include an approximately quadrangular plate shape and be made of metal (e.g., titanium, stainless steel, Inconel, or aluminum).

According to another exemplary embodiment of the present disclosure, the separator may be formed in a shape of a circle or other shapes. The separator may be made of other materials such as graphite or a carbon composite.

The porous base layer 200 is disposed between the membrane electrode assembly 100 and the separator to uniformly distribute (move or discharge) the target fluid (e.g., water or hydrogen) while provided as an electron movement passage.

With reference to FIG. 1 and FIG. 2, the porous base layer 200 includes the base layer body 210 stacked on the membrane electrode assembly (MEA) 100, and the protrusion pattern 220 provided on one surface of the base layer body 210 that faces the membrane electrode assembly 100 (e.g., a bottom surface of the base layer body based on FIG. 1), the protrusion pattern 220 being configured to define the guide flow paths 224 for guiding the movement of the target fluid between the membrane electrode assembly 100 and the base layer body 210.

For example, the base layer body 210 may be provided in a form of an approximately flat plate.

The protrusion pattern 220 is provided to define the guide flow paths 224 for guiding the movement of the target fluid between the membrane electrode assembly 100 and the base layer body 210.

For reference, in the exemplary embodiment of the present disclosure, the guide flow path 224 may be defined as a passageway or space in which the target fluid (e.g., water) may move between the membrane electrode assembly 100 and the base layer body 210 (a space ensured between the membrane electrode assembly 100 and the base layer body 210 in the thickness direction of the membrane electrode assembly 100).

The protrusion pattern 220 may have various structures configured for providing the guide flow paths 224. The present disclosure is not restricted or limited by the structure of the protrusion pattern 220.

According to the exemplary embodiment of the present disclosure, the protrusion pattern 220 may include a plurality of protrusions 222 protruding from one surface of the base layer body 210 and spaced from one another. The guide flow paths 224 may be defined in spaces between the plurality of protrusions 222.

For example, the plurality of protrusions 222 may be provided to include an approximately lattice shape. The guide flow paths 224 may be defined between the plurality of protrusions 222. For example, the plurality of protrusions 222 may be arranged in an n×n matrix.

The protrusion pattern 220, which defines the guide flow paths 224, is provided to uniformly disperse (diffuse) the target fluid over the entire section of the membrane electrode assembly 100 while ensuring the sufficient transfer flow rate of the target fluid.

This is based on the fact that in case that there is a closed pore section (closed pore area) in which closed pores are formed in one surface of the porous base layer 200 being in contact with the membrane electrode assembly 100, the target fluid hardly passes through the closed pore section, which causes a problem in that it is difficult to form a smooth flow of the target fluid in a direction from the separator toward the membrane electrode assembly 100 so that there is a problem in that it is difficult to ensure a sufficient transfer flow rate of the target fluid to be transferred to the membrane electrode assembly 100 (it is difficult to ensure a reaction area of the target fluid to be supplied to the membrane electrode assembly and ensure efficiency in transferring the target fluid), which makes it difficult to improve the performance and output of the electrochemical device.

Moreover, there is a problem in that a dead zone, in which the target fluid cannot be supplied to a particular site of the membrane electrode assembly 100, is formed by the closed pore section, and for the present reason, there is a problem in that the durability of the membrane electrode assembly 100 and the porous base layer 200 deteriorate.

However, in the exemplary embodiment of the present disclosure, the protrusion pattern 220, which defines the guide flow paths 224 for guiding the target fluid, is provided on one surface of the base layer body 210 that faces the membrane electrode assembly 100. Therefore, it is possible to obtain an advantageous effect of uniformly dispersing (diffusing) the target fluid over the entire section of the membrane electrode assembly 100 while ensuring a sufficient transfer flow rate of the target fluid to be transferred to the membrane electrode assembly 100.

Among other things, in the exemplary embodiment of the present disclosure, the protrusion pattern 220, which defines the guide flow paths 224, is provided on a contact surface of the porous base layer 200 which is in contact with the membrane electrode assembly 100 (one surface of the base layer body that faces the membrane electrode assembly) so that the target fluid may be dispersed (diffused) along the guide flow paths 224 even though the closed pore section (closed pore area) is present on the contact surface of the porous base layer 200. Therefore, it is possible to obtain an advantageous effect of ensuring the reaction area of the target fluid to be supplied to the membrane electrode assembly 100 and ensure efficiency in transferring the target fluid.

Moreover, according to the exemplary embodiment of the present disclosure, the target fluid having passed through the porous base layer 200 may be uniformly dispersed (diffused) over the entire section of the membrane electrode assembly 100 along the guide flow paths 224. Therefore, it is possible to obtain an advantageous effect of minimizing the occurrence of the dead zone and improving the durability of the membrane electrode assembly 100 and the porous base layer 200.

Furthermore, in the exemplary embodiment of the present disclosure, the guide flow path 224 (an empty space larger in size of the pore of the porous base layer) is provided on the contact surface of the porous base layer 200 which is in contact with the membrane electrode assembly 100 (one surface of the base layer body that faces the membrane electrode assembly) so that the porosity of the porous base layer 200 may be improved. Therefore, it is possible to improve the transmittance of the target fluid with respect to the porous base layer 200. Furthermore, it is possible to shorten a movement route for the target fluid passing through the porous base layer 200 by reducing the tortuosity in a thickness direction of the porous base layer 200 (an actual movement route compared to a shortest straight route in which the target fluid passes).

For example, the porous base layer (the porous base layer in the related art) excluding the guide flow path 224 includes a porosity of about 40%. However, according to the exemplary embodiment of the present disclosure, the recessed guide flow paths 224 are provided in one surface of the porous base layer 200 so that a porosity of the porous base layer 200 may be implemented to be about 50% or more (e.g., 50% to 70%).

The guide flow paths 224 may be defined in an in-plane direction of the base layer body 210.

The guide flow path 224 may be defined in various in-plane directions of the base layer body 210 in accordance with required conditions and design specifications. The present disclosure is not restricted or limited by the direction of the guide flow paths 224.

According to the exemplary embodiment of the present disclosure, the guide flow paths 224 may include first flow paths 224a defined in the first direction, and second flow paths 224b defined in a second direction intersecting the first direction and configured to fluidically-communicate with the first flow paths 224a.

In the instant case, the configuration in which the first flow path 224a and the second flow path 224b fluidically-communicate with each other may be defined as a configuration in which the first flow path 224a and the second flow path 224b are continuously connected. The target fluid introduced into the guide flow paths 224 (the first flow path or the second flow path) may move from the first flow path 224a to the second flow path 224b or move from the second flow path 224b to the first flow path 224a.

According to the exemplary embodiment of the present disclosure, the second flow path 224b may be provided to be perpendicular to the first flow path 224a.

For example, the first flow path 224a may be defined in an approximately horizontal direction (X-axis direction) of the membrane electrode assembly 100 (or the base layer body), and the second flow path 224b may be defined in an approximately vertical direction (Y-axis direction) of the membrane electrode assembly 100 (or the base layer body). The first flow path 224a and the second flow path 224b may be connected to collectively define an approximately cross shape.

The first flow path 224a may be provided as a plurality of first flow paths 224a spaced from one another in the second direction, and the second flow path 224b may be provided as a plurality of second flow paths 224b spaced from one another in the first direction thereof.

According to the exemplary embodiment of the present disclosure, at least any one of the first flow path 224a and the second flow path 224b may be defined in a straight shape. Hereinafter, an example will be described in which the first flow path 224a and the second flow path 224b are defined in a straight shape.

According to another exemplary embodiment of the present disclosure, at least any one of the first flow path and the second flow path may be defined in a curved shape (e.g., a circular arc shape).

Alternatively, at least any one of the first flow path and the second flow path may be formed to include a structure with a combination of the straight shape and the curved shape.

In the exemplary embodiment of the present disclosure illustrated and described above, the example has been described in which the guide flow path 224 includes the first flow path 224a and the second flow path 224b. However, according to another exemplary embodiment of the present disclosure, the guide flow path may include only a single flow path or three or more flow paths defined in directions intersecting one another.

The protrusions 222, which form the protrusion pattern 220, may be variously changed in sizes in accordance with required conditions and design specifications. The present disclosure is not restricted or limited by the size of the protrusion 222.

According to the exemplary embodiment of the present disclosure, a height H of the protrusion 222, which forms the protrusion pattern 220, may be defined to be 1 to 20 μm.

In the instant case, the configuration in which the height H of the protrusion 222 is defined to be 1 to 20 μm may be understood as a configuration in which a depth of the guide flow path 224 defined between the protrusions 222 is also defined to be 1 to 20 μm.

This is based on the fact that a more sufficient size of the guide flow path 224 may be ensured as the height H of the protrusion 222 increases, and the rigidity of the porous base layer 200 decreases when the height H of the protrusion 222 excessively increases even though the porosity of the porous base layer 200 may increase.

That is, if the height H of the protrusion 222 is smaller than 1 μm, there is a problem in that it is difficult to sufficiently ensure the guide flow path 224 for guiding the target fluid. In contrast, when the height H of the protrusion 222 is greater than 20 μm, there is a problem in that the rigidity of the porous base layer 200 deteriorates. Therefore, the height H of the protrusion 222, which forms the protrusion pattern 220, may be defined to be 1 to 20 μm.

The porous base layer 200 may be manufactured by various methods in accordance with required conditions and design specifications. The present disclosure is not restricted or limited by the method of manufacturing the porous base layer 200.

Hereinafter, a method of manufacturing the porous base layer 200 according to the exemplary embodiment of the present disclosure will be described.

With reference to FIG. 3, the method of manufacturing the porous base layer 200 according to the exemplary embodiment of the present disclosure includes step S10 of providing a release sheet 300 including a concave-convex pattern 310 on one surface, step S20 of forming the porous base layer 200 by applying base layer slurry LS onto one surface of the release sheet 300 to cover the concave-convex pattern 310, and step S30 of removing the release sheet 300 from the porous base layer 200. When the release sheet 300 is removed from the porous base layer 200, the protrusion pattern 220, which defines the guide flow paths 224 corresponding to the concave-convex pattern 310, is formed on one surface of the porous base layer 200.

### Step 1:

First, the release sheet 300 including the concave-convex pattern 310 is provided on one surface (S10).

The release sheet 300 may have various structures each including the concave-convex pattern 310 on one surface thereof. The present disclosure is not restricted or limited by the structure of the release sheet 300.

For example, the release sheet 300 may be provided to be wound in a form of an approximately hollow roll. The concave-convex pattern 310 is provided on one surface of the release sheet 300. According to another exemplary embodiment of the present disclosure, the release sheet may be provided after being cut into a predefined dimension (e.g., a rectangular sheet shape having a length greater than a width).

The concave-convex pattern 310 may have various structures in accordance with required conditions and design specifications. The present disclosure is not restricted or limited by the structure of the concave-convex pattern 310.

With reference to FIG. 4, according to the exemplary embodiment of the present disclosure, the concave-convex pattern 310 may include crest portions 312 protruding from one surface of the release sheet 300, and trough portions 314 connected to end portions of the crest portions 312 to define continuous waveforms together with the crest portions 312 in the in-plane direction of the release sheet 300.

According to the exemplary embodiment of the present disclosure, the crest portion 312 may be provided as a plurality of crest portions 312, and the trough portion 314 may be provided as a plurality of trough portions 314 so that an approximately lattice shape is defined.

The crest portions 312 and the trough portions 314 may be alternately disposed in the first direction and the second direction intersecting the first direction thereof.

In the instant case, the configuration in which the crest portions 312 and the trough portions 314 are alternately disposed in the first direction and the second direction intersecting the first direction may be defined as a configuration in which the crest portions 312 and the trough portions 314 are alternately disposed in the horizontal direction (X-axis direction) and alternately disposed in the vertical direction (Y-axis direction). The first direction may be defined to be perpendicular to the second direction thereof.

The crest portion 312 and the trough portion 314 may be variously changed in structures and shapes in accordance with required conditions and design specifications. The present disclosure is not restricted or limited by the structures and shapes of the crest portion 312 and the trough portion 314. For reference, the structure and shape of the trough portion 314 may vary depending on the structure and shape of the crest portion 312.

For example, with reference to FIG. 4 and FIG. 5, the crest portion 312 and the trough portion 314 may each include an approximately quadrangular shape.

As illustrated in FIG. 6, according to another exemplary embodiment of the present disclosure, the crest portion 312 may include a structure in which an approximately triangular head portion is connected to an upper portion of an approximately quadrangular body.

Alternatively, as illustrated in FIG. 7, the crest portion 312 may include a triangular shape. As illustrated in FIG. 8, the crest portion 312 may include a hemispherical shape.

The release sheet 300 including the concave-convex pattern 310 may be manufactured in various ways in accordance with required conditions and design specifications.

According to the exemplary embodiment of the present disclosure, the concave-convex pattern 310 and the release sheet 300 may be provided as a unitary one-piece structure.

For example, with reference to FIG. 9, the concave-convex pattern 310 and the release sheet 300 may be provided as a unitary one-piece structure by forming the concave-convex pattern 310 pressing (thermally compressing) one surface of the release sheet 300 by use of a pressing roller R (e.g., a heating roller).

As an exemplary embodiment of the present disclosure, with reference to FIG. 10, the concave-convex pattern 310 and the release sheet 300 may be provided as a unitary one-piece structure by forming the concave-convex pattern 310 by applying a liquid release agent 300a onto one surface of the release sheet 300 and then processing and solidifying the liquid release agent 300a by use of the pressing roller R (e.g., a cooling roller).

In the exemplary embodiment of the present disclosure illustrated and described above, the example has been described in which the concave-convex pattern 310 is integrally provided on one surface of the release sheet 300. However, according to another exemplary embodiment of the present disclosure, the concave-convex pattern may be coupled or attached to one surface of the release sheet (bonded by a separate bonding layer). Alternatively, the concave-convex pattern may be formed on one surface of release sheet by partially removing (e.g., machining) one surface of the release sheet by machining processing.

Furthermore, the release sheet 300 and the concave-convex pattern 310 may each be made of various materials in accordance with required conditions and design specifications. The present disclosure is not restricted or limited by the materials and properties of the release sheet 300 and the concave-convex pattern 310.

For example, the release sheet 300 and the concave-convex pattern 310 may be formed by use of at least any one of polyethylene terephthalate (PET), polyethylene naphthalate (PEN), polycyclohexylene dimethylene terephthalate (PCT), low-density polyethylene (LDPE), linear low-density polyethylene (LLDPE), thermoplastic polyurethane (TPU), unstretched polypropylene (CPP), and polyvinylidene fluoride (PVDF).

Furthermore, the release sheet 300 may be configured as a single layer or configured by stacking a plurality of different layers.

### Step 2:

Next, the porous base layer 200 is formed by applying the base layer slurry LS onto one surface of the release sheet 300 to cover the concave-convex pattern 310 (S20).

With reference to FIG. 11, in step S20 of forming the porous base layer 200, the porous base layer 200 may be formed by applying the base layer slurry LS onto one surface of the release sheet 300 to cover the concave-convex pattern 310, thinning and flattening the base layer slurry LS by use of a doctor blade (doctor blade) or the like, and then curing (solidifying) the base layer slurry LS.

The base layer slurry LS may be provided by mixing various materials in accordance with required conditions and design specifications. The present disclosure is not restricted or limited by the types of materials, which form the base layer slurry LS, and the composition ratios of the materials.

For example, the base layer slurry LS may be provided by mixing a metal element, a solvent, a dispersant, and a coupling agent.

Various metal elements may be used as the metal element in accordance with required conditions and design specifications.

According to the exemplary embodiment of the present disclosure, the metal element may include a titanium family element. More particularly, titanium family elements may include at least any one of titanium, zirconium, and hafnium.

According to another exemplary embodiment of the present disclosure, other metal elements such as nickel or stainless steel may be used, instead of the titanium family element, as the metal element.

Furthermore, the metal element (e.g., the titanium family element) may have various shapes configured for manufacturing the porous base layer 200. The present disclosure is not restricted or limited by the shape and structure of the metal element. For example, the metal element (e.g., the titanium family element) may be provided in a shape of a circle, an elliptical shape, an atypical shape, or a fiber shape.

The titanium family element may include an average particle size of 10 μm to 80 μm.

An average particle size of the titanium family element may be 10 μm to 40 μm. If the average particle size of the titanium family element is smaller than 10 μm, there is a problem in that a porosity and pore size of the porous base layer 200 are too low, and brittleness is high. In contrast, when the average size of the titanium family element is greater than 40 μm, the porosity of the porous base layer 200 is too high, illuminance is high, and resistance in a water electrolysis stack increases, which may cause a problem of deterioration in performance. Therefore, the average particle size of the titanium family element may be defined to be 10 μm to 40 μm.

For reference, the average particle size of the titanium family element may be defined as a grain size of cumulative distribution 50% (D₅₀) in the grain size distribution measured by a particle size analyzer (PSA).

According to the exemplary embodiment of the present disclosure, the base layer slurry LS may include a titanium family element of 60 to 98 weight % with respect to the total weight of the base layer slurry LS.

If a titanium family element content is smaller than 60 weight % with respect to the total weight of the base layer slurry LS, a distance between the titanium family elements is long during a process of heat-treating the porous base layer 200 (a degreasing process and a sintering process), which may cause a problem in which the sintering process is not smoothly performed, the porosity of the porous base layer 200 is too high, and the rigidity is low. In contrast, when the titanium family element content is greater than 98 weight % with respect to the total weight of the base layer slurry LS, the porosity of the porous base layer 200 is too low, and the viscosity of the base layer slurry LS is too high, which causes a problem in which the porous base layer 200 cannot be normally manufactured.

Therefore, the titanium family element content may be defined to be 60 to 98 weight % with respect to the total weight of the base layer slurry LS. The titanium family element content may be defined to be 65 to 85 weight % with respect to the total weight of the base layer slurry LS. The titanium family element content may be defined to be 70 to 80 weight % with respect to the total weight of the base layer slurry LS.

Various solvents may be used as a solvent contained in the base layer slurry LS in accordance with required conditions and design specifications. The present disclosure is not restricted or limited by the type and properties of the solvent.

For example, ethanol, toluene, methanol, propanol, butanol, acetone, ketone, cyclohexenone, methyl acetate, and the like may be used as the solvent.

According to the exemplary embodiment of the present disclosure, the base layer slurry LS may include the solvent of 10 to 30 weight % with respect to the total weight of the base layer slurry LS.

If a solvent content is smaller than 10 weight % with respect to the total weight of the base layer slurry LS, the viscosity of the base layer slurry LS is high, and coating properties of a composition (base layer slurry) deteriorate. For the present reason, a thickness of the porous base layer 200 may not be uniform, the excessive deviation of porosity and pore sizes may occur for each position of the porous base layer 200. In contrast, if the solvent content is greater than 30 weight % with respect to the total weight of the base layer slurry LS, the solvent is excessively evaporated during a process of sintering the porous base layer 200, which may cause a problem in which the material and devices are contaminated, or it is difficult to satisfy a target thickness, a target porosity, and a target pore size.

Therefore, the solvent content may be defined to be 10 to 30 weight % with respect to the total weight of the base layer slurry LS. The solvent content may be defined to be 15 to 30 weight % with respect to the total weight of the base layer slurry LS. The solvent content may be defined to be 20 to 30 weight % with respect to the total weight of the base layer slurry LS.

Various dispersants may be used as a dispersant contained in the base layer slurry LS in accordance with required conditions and design specifications. The present disclosure is not restricted or limited by the type and properties of the dispersant.

For example, at least any one of water, ethanol, methanol, isopropanol, xylene, cyclohexanone, acetone, and methyl ethyl ketone may be used as the dispersant.

According to the exemplary embodiment of the present disclosure, the base layer slurry LS may include the dispersant of 0.1 to 3 weight % with respect to the total weight of the base layer slurry LS.

If a dispersant content is smaller than 0.1 weight % with respect to the total weight of the base layer slurry LS, there may occur a problem in which particles of the titanium family elements are aggregated during a process of manufacturing a composition (base layer slurry). In contrast, if the dispersant content is greater than 3 weight % with respect to the total weight of the base layer slurry LS, the viscosity of the composition (base layer slurry) is too low to perform a coating process, which may cause a problem in which workability is insufficient.

Therefore, the dispersant content may be defined to be 0.1 to 3 weight % with respect to the total weight of the base layer slurry LS. The dispersant content may be defined to be 1 to 3 weight % with respect to the total weight of the base layer slurry LS. The dispersant content may be defined to be 1.5 to 2.3 weight % with respect to the total weight of the base layer slurry LS.

Various coupling agents may be used as a coupling agent contained in the base layer slurry LS in accordance with required conditions and design specifications. The present disclosure is not restricted or limited by the type and properties of the dispersant.

For example, at least any one of polyvinyl butyral (PVB), polyvinyl alcohol (PVA), polyvinyl chloride (PVC), polyvinyl acetate (PVAc), and polyacrylonitrile may be used as the coupling agent.

According to the exemplary embodiment of the present disclosure, the base layer slurry LS may include the coupling agent of 0.1 to 5 weight % with respect to the total weight of the base layer slurry LS.

If a coupling agent content is smaller than 0.1 weight % with respect to the total weight of the base layer slurry LS, a binding force is insufficient between particles of the titanium family elements in the porous base layer 200, which may cause a problem in which the porous base layer 200 is hardly kept in a sheet shape. In contrast, if the coupling agent content is greater than 5 weight % with respect to the total weight of the base layer slurry LS, the binding force between the components in the composition (base layer slurry) is high, which may cause a problem in which the coupling agent attached to a lower substrate (e.g., the release sheet) during a coating process.

Therefore, the coupling agent content may be defined to be 0.1 to 4 weight % with respect to the total weight of the base layer slurry LS. The coupling agent content may be defined to be 1 to 4 weight % with respect to the total weight of the base layer slurry LS. The coupling agent content may be defined to be 2 to 3.5 weight % with respect to the total weight of the base layer slurry LS.

For reference, the base layer slurry LS may be manufactured by stirring (e.g., mixing in a ball mill process) the titanium family element, the solvent, the dispersant, and the coupling agent. For example, the stirring process may be performed by appropriately mixing zirconia balls with 5 to 30 mm with the base layer slurry LS. The stirring time of the base layer slurry LS may be 1 hour or more, 10 to 30 hours, or 18 to 24 hours. The composition (base layer slurry) with a viscosity of 1,000 to 8,000 cp may be manufactured by uniformly dispersing the mixture for 12 hours or more on average.

### Step 3:

Next, the release sheet 300 is removed from the porous base layer 200 (S30).

With reference to FIG. 12, when the release sheet 300 is removed (separated) from the porous base layer 200, the protrusion pattern 220, which defines the guide flow paths 224 corresponding to the concave-convex pattern 310, may be formed on one surface of the porous base layer 200.

For example, the protrusion pattern 220 may include the plurality of protrusions 222 protruding from one surface of the release sheet 300 and spaced from one another to define an approximately lattice shape (e.g., the n×n matrix). The guide flow paths 224 may be defined as spaces between the plurality of protrusions 222.

The porous base layer 200, which is manufactured by the method of manufacturing the porous base layer 200 according to the exemplary embodiment of the present disclosure as described above, may be ascertained in FIG. 2.

Meanwhile, the porous base layer 200, which has been separated from the release sheet 300, is cut into a predefined dimension and then subjected to a heat treatment process (a degreasing process and a sintering process).

The process of degreasing the porous base layer 200 may be performed at various temperatures at which the solvent in the porous base layer 200 may be removed.

According to the exemplary embodiment of the present disclosure, the process of degreasing the base layer slurry LS may be performed under a condition of 300 to 700° C. at an inert gas ambience.

If a temperature of the process of degreasing the base layer slurry LS is lower than 300° C., there may occur a problem in that the solvent remains without being evaporated totally. In contrast, if the temperature of the processing of degreasing the base layer slurry LS is higher than 700° C., there may occur a problem in that the titanium family element is oxidized in an environment which is not a high-vacuum ambience. Therefore, the temperature of the processing of degreasing the base layer slurry LS may be defined to be 300 to 700° C. The temperature of the processing of degreasing the base layer slurry LS may be defined to be 350 to 600° C. The temperature of the processing of degreasing the base layer slurry LS may be defined to be 400 to 500° C.

An inert gas used for the process of degreasing the base layer slurry LS may be variously changed in types and properties in accordance with required conditions and design specifications. The present disclosure is not restricted or limited by the type and properties of the inert gas. For example, argon (Ar) gas may be used as the inert gas.

For reference, the process of degreasing the base layer slurry LS may raise the temperature at 1 to 3° C./min and be maintained at the corresponding temperature for 2 hours.

The process of sintering the porous base layer 200 may be performed under various temperature and pressure conditions in accordance with required conditions and design specifications.

According to the exemplary embodiment of the present disclosure, the process of sintering the base layer slurry LS may be performed under a temperature condition of 900 to 1,500° C. and a pressure condition of 1×10⁻⁵ Torr or less.

If a temperature of the process of sintering the base layer slurry LS is lower than 900° C., the titanium family element in the porous base layer 200 is not sintered, which may cause a problem in which the pore is too large, or the rigidity is low. In contrast, when the temperature for sintering the base layer slurry LS is higher than 1500° C., the titanium family element of the porous base layer 200 is excessively sintered, which may cause a problem in which the pore is clogged.

Furthermore, if the pressure of the process of sintering the base layer slurry LS is in a low-vacuum state (e.g., higher than 1×10⁻⁵ Torr), there may occur a problem in that the titanium family element in the porous base layer 200 is oxidized, or the porous base layer 200 is contaminated by contaminants in a sintering furnace. In contrast, if the pressure of the process of sintering the base layer slurry LS is in a high-vacuum state higher than necessary (e.g., lower than 1×10⁻⁸ Torr) a high-specification vacuum pump and means are required, which may cause a problem in which process costs and process time increase.

Therefore, the process of sintering the base layer slurry LS may be performed under the temperature condition of 900 to 1,500° C. and the pressure condition of and 1×10″ 5 Torr or less. The process of sintering the base layer slurry LS may be performed under a temperature condition of 950 to 1,300° C. and a vacuum condition of 1×10⁻⁵ to 1×10⁻⁸ Torr. The process of sintering the base layer slurry LS may be performed under a temperature condition of 950 to 1,250° C. and a pressure condition of 5×10⁻⁷ Torr.

According to the exemplary embodiment of the present disclosure as described above, it is possible to obtain an advantageous effect of improving performance and operational efficiency.

According to the exemplary embodiment of the present disclosure, it is possible to obtain an advantageous effect of effectively diffusing the target fluid (ensuring diffusion performance) and minimizing a site of the membrane electrode assembly to which the target fluid is not supplied.

Among other things, according to the exemplary embodiment of the present disclosure, it is possible to obtain an advantageous effect of effectively diffusing the target fluid in the in-plane direction of the membrane electrode assembly.

Furthermore, according to the exemplary embodiment of the present disclosure, it is possible to obtain an advantageous effect of improving the transmittance of the porous base layer and improving the efficiency in moving the target fluid (performance in transmitting the target fluid).

Furthermore, according to the exemplary embodiment of the present disclosure, it is possible to obtain an advantageous effect of improving the stability, reliability, and durability.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the exemplary embodiment of the present disclosure, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A porous base layer comprising:
a base layer body stacked on a membrane electrode assembly (MEA); and
a protrusion pattern provided on one surface of the base layer body that faces the membrane electrode assembly, the protrusion pattern being configured to define a guide flow path for guiding a movement of a target fluid between the membrane electrode assembly and the base layer body.

2. The porous base layer of claim 1,
wherein the protrusion pattern includes a plurality of protrusions protruding from the one surface of the base layer body and spaced from one another, and
wherein the guide flow path is defined as a space between the plurality of protrusions.

3. The porous base layer of claim 1, wherein the guide flow path is defined in an in-plane direction of the base layer body.

4. The porous base layer of claim 1, wherein the guide flow path includes:
a first flow path defined in a first direction thereof; and
a second flow path defined in a second direction intersecting the first direction and configured to fluidically-communicate with the first flow path.

5. The porous base layer of claim 4, wherein the first flow path is provided as a plurality of first flow paths spaced from one another in the second direction, and the second flow path is provided as a plurality of second flow paths spaced from one another in the first direction.

6. The porous base layer of claim 4, wherein the second flow path is provided to be perpendicular to the first flow path.

7. The porous base layer of claim 4, wherein at least one of the first and second flow paths is defined in a straight shape.

8. The porous base layer of claim 4, wherein at least one of the first and second flow paths is defined in a curved shape.

9. The porous base layer of claim 2, wherein a height of the protrusion is defined to be 1 to 20 μm.

10. An apparatus for manufacturing a porous base layer, the apparatus comprising:
a release sheet configured to define a coating surface coated with a base layer slurry for forming a porous base layer; and
a concave-convex pattern provided on the coating surface of the release sheet,
wherein the concave-convex pattern is configured to form a protrusion pattern that defines a guide flow path, which guides a movement of a target fluid, on one surface of the porous base layer.

11. The apparatus of claim 10, wherein the concave-convex pattern and the release sheet are provided as a unitary one-piece structure.

12. The apparatus of claim 11, wherein the concave-convex pattern and the release sheet are provided as the unitary one-piece structure by forming the concave-convex pattern by applying a liquid release agent onto one surface of the release sheet and then processing and solidifying the liquid release agent by use of a pressing roller.

13. The apparatus of claim 10, wherein the concave-convex pattern includes:
a crest portion protruding from one surface of the release sheet; and
a trough portion connected to an end portion of the crest portion to define a continuous waveform together with the crest portion in an in-plane direction of the release sheet, and
wherein the guide flow path is formed to correspond to the trough portion.

14. The apparatus of claim 13, wherein the crest portion and the trough portion are respectively provided as a plurality of crest portions and a plurality of trough portions to define a lattice shape.

15. The apparatus of claim 14, wherein the crest portions and the trough portions are alternately disposed in a first direction and a second direction intersecting the first direction.

16. The apparatus of claim 15, wherein the first direction is defined to be perpendicular to the second direction.

17. The apparatus of claim 15, wherein the crest portion include a structure in which a triangular head portion is connected to an upper portion of a quadrangular body, a structure including a triangular shape, or a structure including a hemispherical shape.

18. A method of manufacturing a porous base layer, the method comprising:
providing a release sheet including a concave-convex pattern on one surface;
forming a porous base layer by applying base layer slurry on the one surface of the release sheet to cover the concave-convex pattern; and
removing the release sheet from the porous base layer,
wherein when the release sheet is removed from the porous base layer, a protrusion pattern, which defines a guide flow path corresponding to the concave-convex pattern, is formed on one surface of the porous base layer.
